(19) United States
(12) Patent Application Publication
(10) Pub. No.: US 2024/0314721 A1
(43) Pub. Date: Sep. 19, 2024

(54) ANGLE-BASED POSITIONING VIA A REPEATER

(71) Applicant: QUALCOMM Incorporated, San Diego, CA (US)

(72) Inventors: Navid ABEDINI, Basking Ridge, NJ (US); Sony AKKARAKARAN, Poway, CA (US)

(21) Appl. No.: 18/183,097

(22) Filed: Mar. 13, 2023

(51) Int. Cl. H04W 64/00

(52) U.S. Cl. CPC H04W 64/00

(57) ABSTRACT

In an aspect, a network entity may receive at least one of spatial direction information associated with a repeater or beam antenna information associated with the repeater. The network entity may obtain an indication of a set of beam indexes corresponding to a set of beams associated with the repeater. The network entity may provide, for a network node, a request to transmit a set of reference signals or to perform a set of measurements for a positioning session based on the set of beam indexes and at least one of the spatial direction information or the beam antenna information.

### TECHNICAL FIELD

The present disclosure relates generally to positioning systems, and more particularly, to positioning systems involving a repeater.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a network entity are provided. The apparatus may include memory and at least one processor coupled to the memory. The at least one processor, based at least in part on information stored in the memory may be configured to receive at least one of spatial direction information associated with a repeater or beam antenna information associated with the repeater, obtain an indication of a set of beam indexes corresponding to a set of beams associated with the repeater, and provide, for a network node, a request to transmit a set of reference signals or to perform a set of measurements for a positioning session based on the set of beam indexes and at least one of the spatial direction information or the beam antenna information.

In another aspect of the disclosure, a method, a computer-readable medium, and an apparatus at a network node are provided. The apparatus may include memory and at least one processor coupled to the memory. The at least one processor, based at least in part on information stored in the memory may be configured to obtain at least one of spatial direction information associated with a repeater or beam antenna information associated with the repeater, provide, for a network entity, an indication of a set of beam indexes corresponding to a set of beams associated with the repeater, and receive, from the network entity, a request to transmit a set of reference signals for a positioning session based on the set of beam indexes and at least one of the spatial direction information or the beam antenna information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating a repeater in accordance with various aspects of the present disclosure.

FIG. 6 is a call flow diagram illustrating a method of wireless communication in accordance with various aspects of this present disclosure.

FIG. 7 is a call flow diagram illustrating a method of wireless communication in accordance with various aspects of this present disclosure.

FIG. 8 is a flowchart illustrating methods of wireless communication in accordance with various aspects of the present disclosure.

FIG. 9 is a flowchart illustrating methods of wireless communication in accordance with various aspects of the present disclosure.

FIG. 10 is a diagram illustrating an example of a hardware implementation for an example apparatus and/or network entity.

FIG. 11 is a diagram illustrating an example of a hardware implementation for an example network entity.

FIG. 12 is a diagram illustrating an example of a hardware implementation for an example network entity.

### DETAILED DESCRIPTION

Various aspects relate generally to positioning systems. Some aspects more specifically relate to angle-based positioning based on reference signals transmitted by a repeater. In some examples, a network entity (e.g., a location management function (LMF)) may obtain spatial direction information associated with a repeater (e.g., the angle at which each reference signal transmitted by the repeater is transmitted) and/or beam antenna information associated with the repeater (e.g., the shape of the beam utilized by the repeater for transmission of the reference signals). The network entity may also obtain (e.g., from a network node) an indication of a set of beam indexes corresponding to a set of beams associated with the repeater. The network entity may, based on the set of beam indexes and the spatial direction information and/or the beam antenna information, provide a request (e.g., to the network node) to transmit a set of reference signals or a request (e.g., to a UE) to perform a set of measurements for a positioning session.

Particular aspects of the subject matter described in this disclosure can be implemented to realize one or more of the following potential advantages. In some examples, by considering the spatial information and/or beam antenna information of a repeater when performing the positioning session, the angles at which the repeater transmits reference signals and the beam shape of the beam utilized to transmit such reference signals may be determined. Such information may be leveraged to more accurately determine a positioning result or state (e.g., the location, heading, and/or velocity) of a target entity.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUS may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

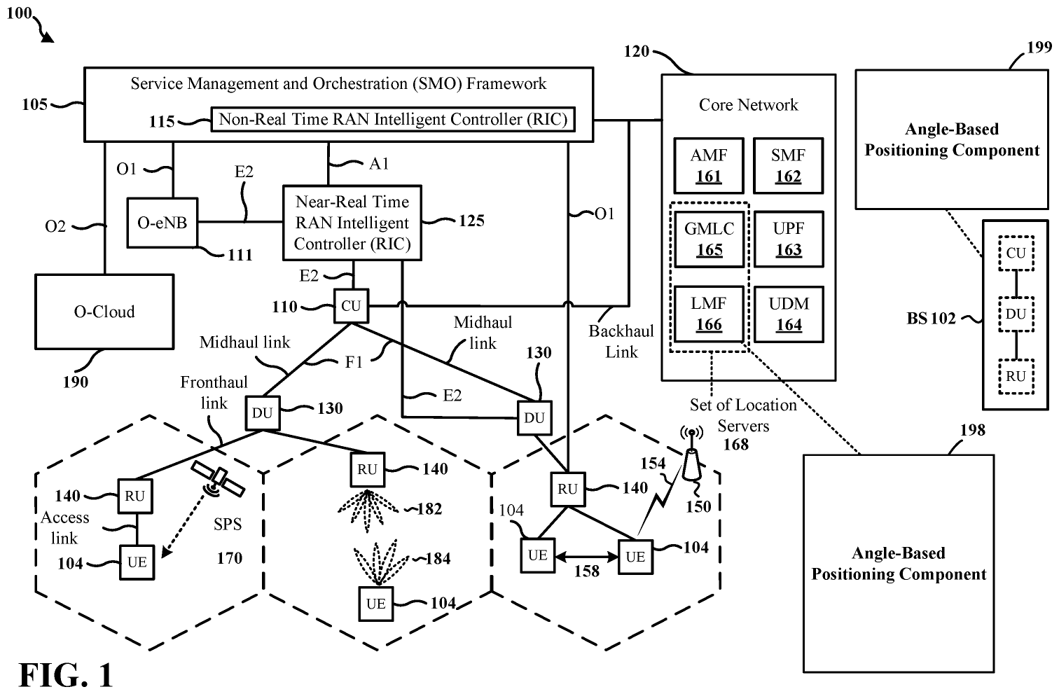

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the LMF 166 may have an angle-based positioning component 198 that may be configured to receive at least one of spatial direction information associated with a repeater or beam antenna information associated with the repeater, obtain an indication of a set of beam indexes corresponding to a set of beams associated with the repeater, and provide, for a network node, a request to transmit a set of reference signals or to perform a set of measurements for a positioning session based on the set of beam indexes and at least one of the spatial direction information or the beam antenna information. In certain aspects, the base station 102 may have an angle-based positioning component 199 that may be configured to obtain at least one of spatial direction information associated with a repeater or beam antenna information associated with the repeater, provide, for a network entity, an indication of a set of beam indexes corresponding to a set of beams associated with the repeater, and receive, from the network entity, a request to transmit a set of reference signals for a positioning session based on the set of beam indexes and at least one of the spatial direction information or the beam antenna information.

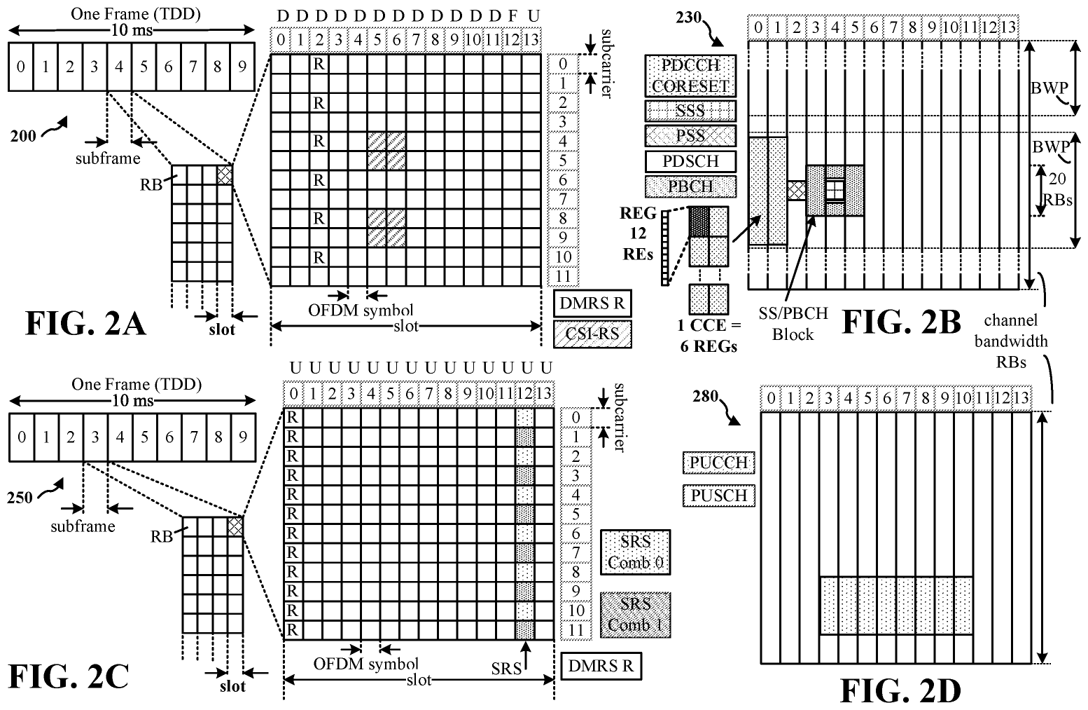

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

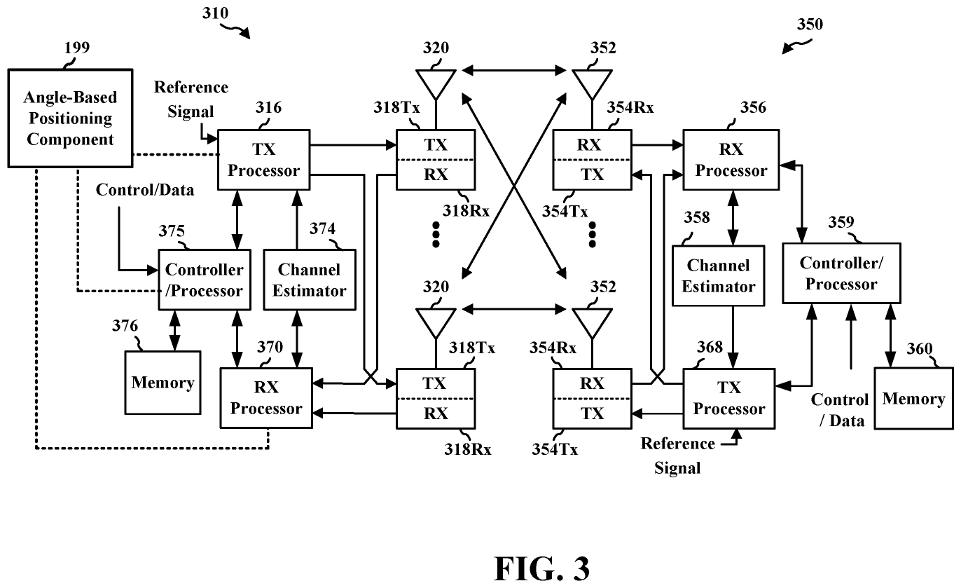

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the angle-based positioning component 199 of FIG. 1.

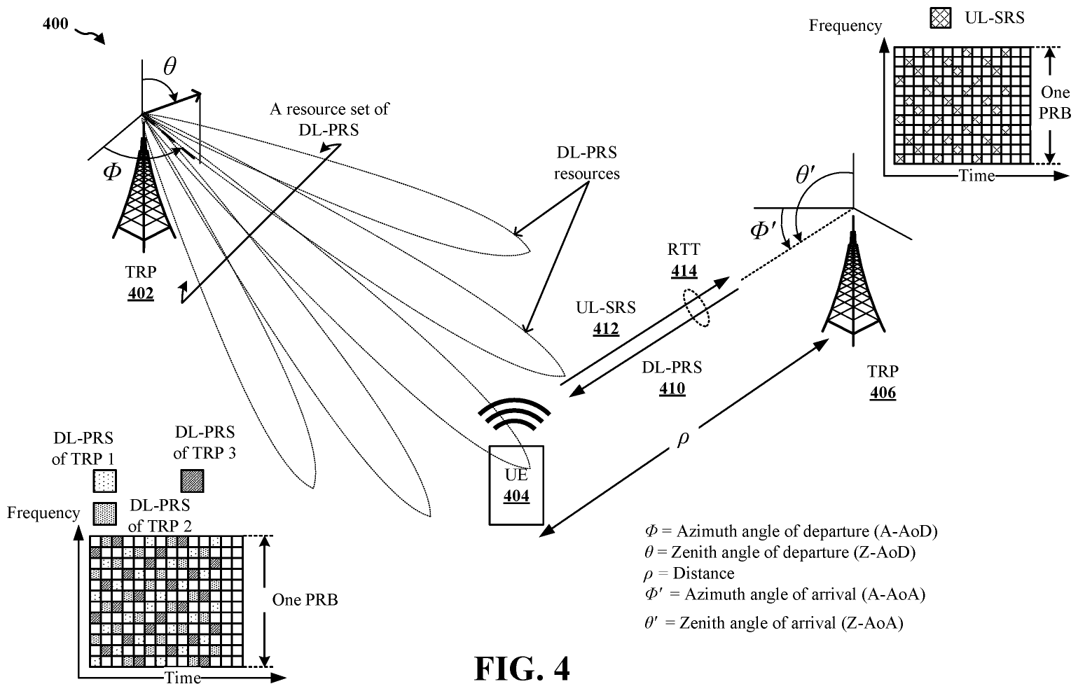

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

For purposes of the present disclosure, a positioning session may refer to the transmitting, the receiving, and the measuring of reference signals for the purposes of determining a positioning result or state (e.g., a location, a heading, a velocity, etc.) of a target entity. A target entity may be any object (e.g., a person, a vehicle, a UE, etc.) for which a positioning session is performed, for example, to determine a location thereof, a velocity thereof, a heading thereof, etc.

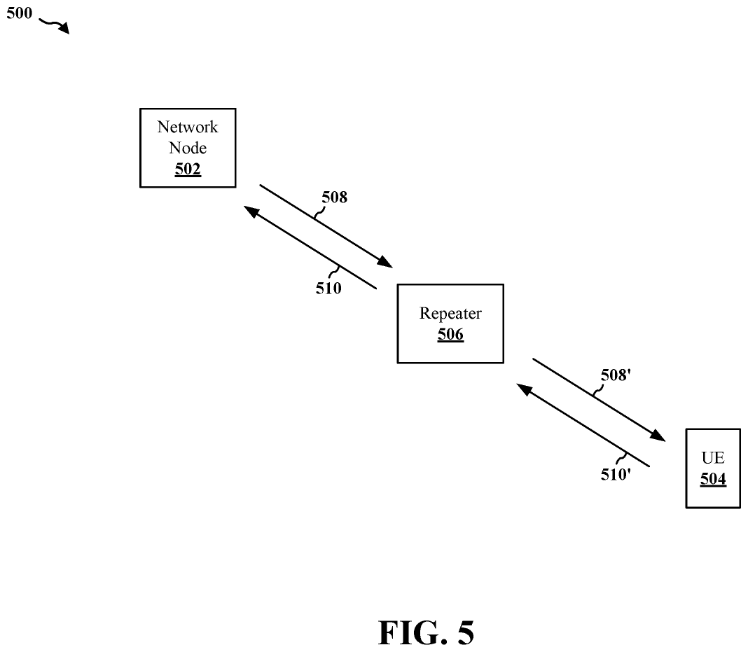

A repeater (e.g., a network-controlled repeater (NCR)) or repeating device may be used to forward positioning references for positioning of a remote UE. For example, FIG. 5 is a diagram 500 illustrating a repeater 506 in accordance with various aspects of the present disclosure. As shown in FIG. 5, the repeater 506 may receive downlink signals 508 from a network node 502 and forward the downlink signals (shown as downlink signals 508′) to a remote UE 504. Similarly, the repeater 506 may receive uplink signals 510 from the remote UE 504 and forward the uplink signals (shown as signals 510′) to the network node 502. While the repeater 506 just forwards the downlink signals 508 (e.g., with no or minimal processing), and hence the network node 502 (e.g., a gNB) may be the logical source/destination of downlink/uplink signals, the repeater 506 may be considered as the physical source/destination for positioning purposes.

For angle-based positioning, the angular information of the access beams used by the NCR (e.g., the repeater 506) for forwarding reference signals (e.g., DL-PRSs or UL-SRSs) may be considered. Aspects of the present disclosure are directed to techniques for utilizing angular information for angle-based positioning.

A repeater may be treated as a TRP (e.g., the TRP 402 or the TRP 406) in the context of positioning. In legacy positioning procedures, TRP information may be exchanged between different entities (e.g., from the DU 130 to the CU 110, from the CU 110 to the LMF 166, from the LMF 166 to the UE 104, etc.). The TRP information for a particular TRP may include spatial direction information, which may indicate angular directions associated with each DL-PRS sent from the particular TRP (e.g., the angle at which the DL-PRS is sent from the particular TRP). The TRP information may additionally include TRP beam antenna information, which may include the shape of the beam utilized to transmit the DL-PRS. The shape of the beam may be described in terms of the power of the beam in different directions (e.g., the azimuth, the elevation, etc.).

The spatial direction information and/or the beam antenna information of a repeater may be acquired in various ways. For example, the LMF 166 may acquire this information, from an operations, administration, and management (OAM) (e.g., an OAM server or node). The OAM node may be managed by a cellular service provider. The OAM may include processes, activities, tools, and standards utilized for operating, administering, managing and maintaining IAB nodes. The spatial direction information of the repeater may indicate angular directions associated with each reference signal (e.g., DL-PRSs) transmitted (or to be transmitted) from the repeater (e.g., the angle at which the reference signals are transmitted (or are to be transmitted) from the repeater). The beam antenna information may indicate the shape of the beam utilized by the repeater for transmission of the reference signals. The shape of the beam may be described in terms of the power of the beam in different directions (e.g., the azimuth, the elevation, etc.).

A network node (e.g., the DU 130 and/or the CU 110 of a gNB) may or may not receive the spatial direction information and/or the beam antenna information of a repeater from the OAM node. In either case, and assuming the LMF 166 has acquired the spatial direction information and/or the beam antenna information from the OAM node, the network node may not provide detailed spatial direction and/or beam antenna information of the repeater when exchanging TRP/PRS information with the LMF 166. Instead, a beam index referring to a set of OAM-configured/indicated beams may be used (i.e., a new beam index may replace other information elements (IEs) used to characterize the angular/beam shape information). In some aspects, the LMF 166 may provide, to the network node, information indicative that the LMF 166 has acquired the spatial direction information and/or beam antenna information of the repeater. In other aspects, the network node may be configured to assume that LMF 166 has acquired such information. In either case, the network node may store, e.g., in a memory or cache thereof, an indication that the LMF 166 acquires such information. In some aspects, a UE may acquire the spatial direction information and/or beam antenna information of the repeater from the OAM node. In such a case, logical beam indexes may be used when exchanging TRP/PRS information with the UE.

In legacy techniques, the LMF 166 may indicate the desired quasi-co-location (QCL) information for the PRSs, where the QCL information refers to an SSB or another DL-PRS index. The QCL information may indicate to a TRP which direction to transmit the DL-PRSs. In some aspects, the LMF 166 may utilize a beam index (from the beam indexes provided by the network node, as described above) referring to a set of OA-configured to indicate the desired QCL information of a PRS. The QCL information may be included in a PRS configuration request message to support logical beam indexes.

In some aspects, the LMF 166 and/or a network node (e.g., the DU 130 and/or the CU 110 of a gNB) may request the repeater and/or the OAM node associated with the repeater the desired spatial information (e.g., in terms of angular direction and/or beam shape) for the beams to be used for PRS transmission and/or SRS reception. That is, the LMF 166 and/or the network node may specify certain characteristics of the transmit beams of the repeater that it would like the repeater to apply when transmitting PRSs and/or SRSs. The spatial direction IE and/or TRP beam antenna information IE in the TRP information may be leveraged for this signaling.

For uplink measurements, in legacy techniques, the LMF 166 may send a measurement request to the network node (e.g., a gNB) to perform and report positioning measurements (e.g., based on the UL-SRS sent by a UE). The LMF 166 may provide assistance information, such as AoA search window information. In some aspects, the LMF 166 may provide assistance information for UL-AoA measurements, where it indicates a set of (or a range of) beam indexes that may be used for the measurements. The beam indexes may refer to a set of OAM-configured/indicated repeater/TRP beams. In some aspects, the LMF 166 may indicate one or more multiple beam indexes to be used for measurements and reports.

In legacy techniques, for uplink measurements, the network node (e.g., the gNB) may send a measurement response to report its UL-based measurements. The report may include angular information, such as the estimated UL-AoA, the Z-AoA, and/or the multiple-AoA. In some aspects, the network node may report (e.g., from the DU 130 to the CU 110, from the CU 110 to the LMF 166) the UL-based measurement, where instead of including angular information, the associated repeater/TRP receive beam used for the measurement is reported. It is noted that for legacy beam information, the QCL information of the beam used for reception may be reported. The QCL information IE may be extended to include logical beam indexes.

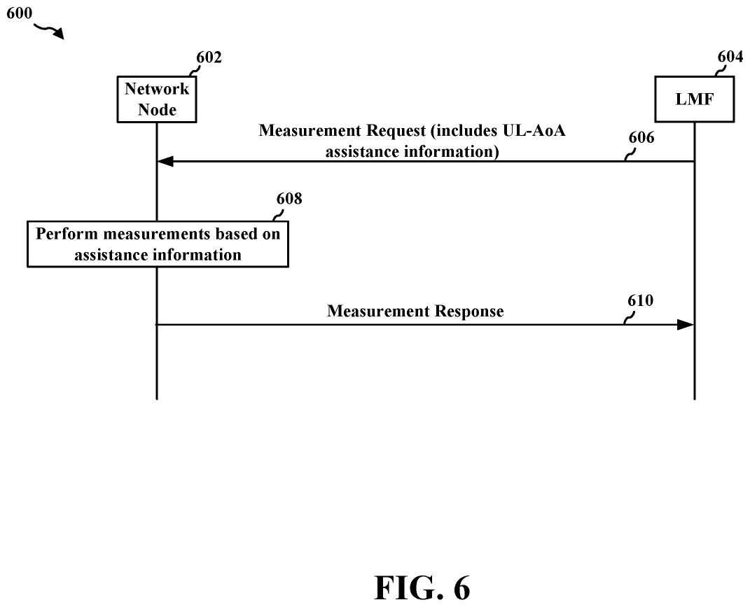

For example, FIG. 6 is a call flow diagram illustrating a method of wireless communication in accordance with various aspects of the present disclosure. As shown in FIG. 6, the diagram 600 includes a network node 602 and an LMF 604. The network node 602 may be an example of the base station 102, the base station 310, the TRP 402, the TRP 406, or the network node 502. The LMF 604 may be an example of the LMF 166. Although aspects are described for the network node 602, the aspects may be performed by the network node 602 in aggregation and/or by one or more components of the network node 602 (e.g., such as a CU 110, a DU 130, and/or an RU 140). As shown in FIG. 6, at 606, the LMF 604 may provide a measurement request to the network node 602. The measurement request may include assistance information for UL-AoA measurements. At 608, the network node 602 may perform the measurements based on the assistance information (e.g., UL-AoA measurements, Z-AoA measurements, multiple-AoA measurements, etc.). At 610, the network node 602 may provide a measurement response to the LMF 604. The measurement response may include the measurements performed at 608, along with the associated repeater/TRP receive beam used for the measurements.

In some aspects, the network node (e.g., the DU 130 and/or the CU 110 of a gNB) may not have acquired positioning-specific beam information from the OAM node. In such instances, the LMF 166 may share the acquired information with the CU 110, which in turn, provides the acquired information with the DU 130.

In some aspects, a repeater may support different codebooks (i.e., different sets of beams) for normal operation (e.g., operations for forwarding communication signals) and for positioning. The repeater may signal, to the LMF 166, an identifier (ID) that identifies a codebook associated with each particular beam of the repeater.

In some aspects, in cases in which a repeater/TRP does not have beam reciprocity, logical beam indexing may be utilized to differentiate between downlink beams and uplink beams. The repeater may signal, to the LMF 166, an ID that identifies whether each of its beams is a downlink beam or an uplink beam.

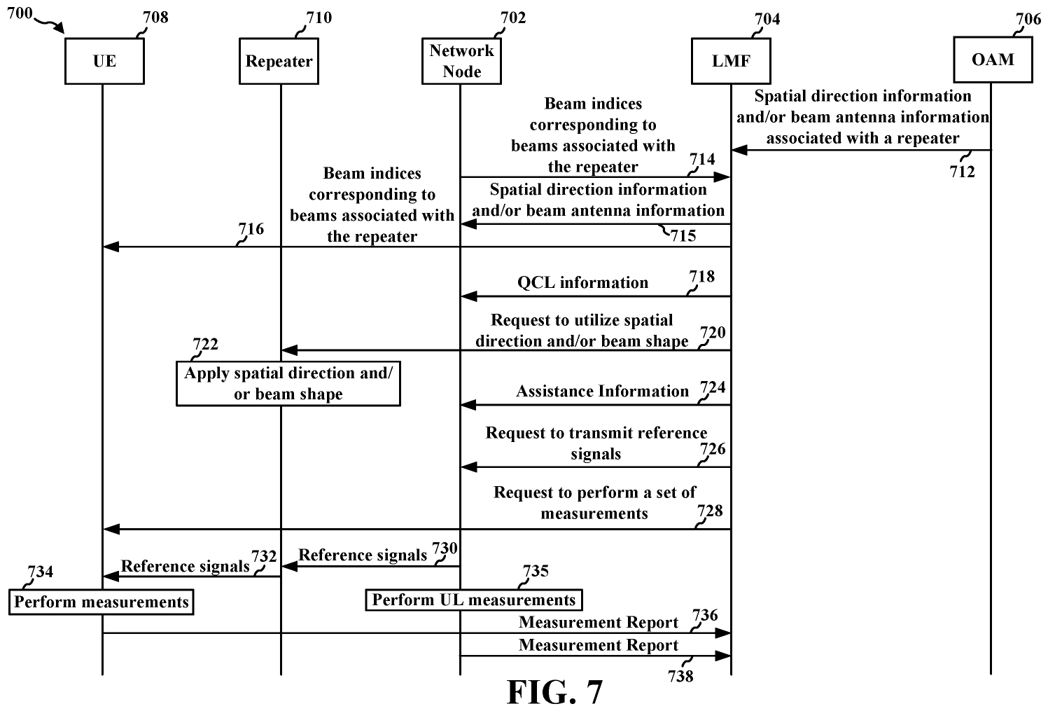

FIG. 7 is a call flow diagram illustrating a method of wireless communication in accordance with various aspects of the present disclosure. As shown in FIG. 7, the diagram 700 includes a network node 702, an LMF 704, an OAM node 706, a UE 708, and a repeater 710. The network node 702 may be an example of the base station 102, the base station 310, the TRP 402, the TRP 406, the network node 502, or the network node 602. The LMF 704 may be an example of the LMF 166 or the LMF 604. The UE 708 may be an example of the UE 104, the UE 350, the UE 404, or the UE 504. The repeater 710 may be an example of the repeater 506. Although aspects are described for the network node 702, the aspects may be performed by the network node 702 in aggregation and/or by one or more components of the network node 702 (e.g., such as a CU 110, a DU 130, and/or an RU 140). As shown in FIG. 7, at 712, the OAM node 706 may provide, to the LMF 704, spatial direction information and/or beam antenna information associated with the repeater 710. The spatial direction information may indicate angular directions associated with each reference signal (e.g., DL-PRSs) transmitted (or to be transmitted) from the repeater 710 (e.g., the angle at which the reference signals are transmitted (or are to be transmitted) from the repeater 710). The beam antenna information may indicate the shape of the beam utilized by repeater 710 for transmission of the reference signals. The shape of the beam may be described in terms of the power of the beam in different directions (e.g., the azimuth, the elevation, etc.).

At 714, the network node 702 may provide, to the LMF 704, an indication of a set of beam indexes corresponding to a set of beams associated with the repeater 710. The set of beams associated with the repeater 710 may be configured by the OAM node 706. It is noted that in some aspects, the set of beam indexes corresponding to the set of beams associated with the repeater 710 may be provided to the LMF 704 by the OAM node 706, for example, at 712.

In some aspects, at 714, the network node 702 may also provide, to the LMF 704, an ID that identifies a codebook associated with each of the set of beams corresponding to the set of beam indexes.

In some aspects, at 714, the network node 702 may also provide, to the LMF 704, an ID that identifies whether the set of beams corresponding to the set of beam indexes is a downlink beam or an uplink beam.

In some aspects, at 715, the LMF 704 may provide, to the network node 702, the spatial direction information and/or beam antenna information based on the reception of the spatial direction information and/or beam antenna information associated with the repeater 710 received at 712.

In some aspects, at 716, the LMF 704 may provide, to the UE 708, the set of beam indexes corresponding to the set of beams associated with the repeater 710 based on the indication of the set of beam indexes received at 714.

At 718, the LMF 704 may provide, to the network node 702, QCL information for at least one PRS associated with the repeater 710 based on the at least one beam index of the set of beam indexes. For example, the LMF 704 may utilize at least one beam index of the set of beam indexes received at 714 to indicate desired QCL information of the at least one PRS.

At 719, the network node 702 may provide, to the repeater 710, a request to forward a set of reference signals (e.g., at 732, as described below) based on the QCL information.

At 720, the LMF 704 may provide, to the repeater 710, a request to utilize a particular spatial direction and/or a particular beam shape for at least one transmit or receive beam of the repeater 710.

At 722, the repeater 710 may apply the particular spatial direction and/or the particular beam shape for at least one transmit or receive beam thereof. For example, the repeater 710 may configure at least one transmit or receive beam thereof to utilize the particular spatial direction and/or the particular beam shape.

At 724, the LMF 704 may provide, to the network node 702, assistance information. The assistance information may indicate one or more beam indexes from the set of beam indexes received at 714 that can be used for performing a set of uplink measurements (e.g., uplink AoA measurements) for a positioning session at the network node 702.

At 726, the LMF 704 may provide, to the network node 702, a request to transmit a set of reference signals for a positioning session based on the set of beam indexes and at least one of the spatial direction information or the beam antenna information.

At 728, the LMF 704 may provide, to the UE 708 and/or the network node 702, a request to perform a set of measurements for the positioning session based on the set of beam indexes and at least one of the spatial direction information or the beam antenna information.

At 730, the network node 702 may provide (e.g., transmit) the set of reference signals based on the spatial direction information, the beam antenna information, the one or more beam indexes, and/or the QCL information received at 718. The set of reference signals may be transmitted to and received by the repeater 710.

At 732, the repeater 710 may transmit (e.g., forward) the received set of reference signals to the UE 708.

At 734, the UE 708 may perform the set of measurements for the positioning session. For example, the UE 708 may perform the set of measurements based on set of reference signals received at 732.

At 735, the network node 702 may perform a set of uplink measurements for the positioning session. For example, the UE 708 may transmit a set of uplink reference signals (not shown for brevity) to the repeater 710, and the repeater 710 may forward the set of uplink reference signals (not shown for brevity) to the network node 702. The network node 702 may perform the set of uplink measurements based on the set of uplink reference signals transmitted by the repeater 710. The set of uplink measurements may be uplink AoA measurements.

At 736, the UE 708 may provide, to the LMF 704, a measurement report that may be based on the set of measurements, where the measurement report includes an ID of a receive beam associated with the repeater 710 utilized for the set of measurements.

At 738, the network node 702 may provide, to the LMF 704, a measurement report that may be based on the set of uplink AoA measurements performed at 735. The measurement report may include an ID of a receive beam associated with the repeater 710 utilized for the set of uplink AoA measurements (e.g., the receive beam via which the set of uplink reference signals are provided by the repeater 710).

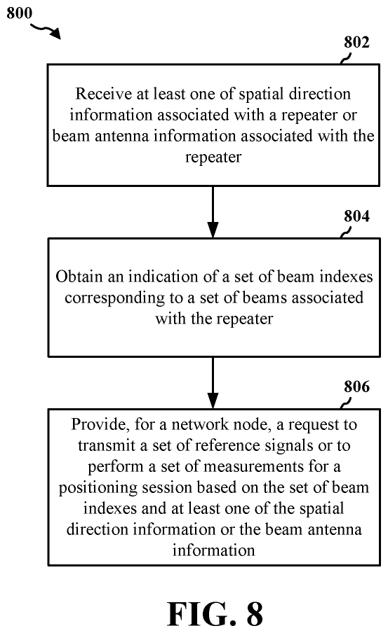

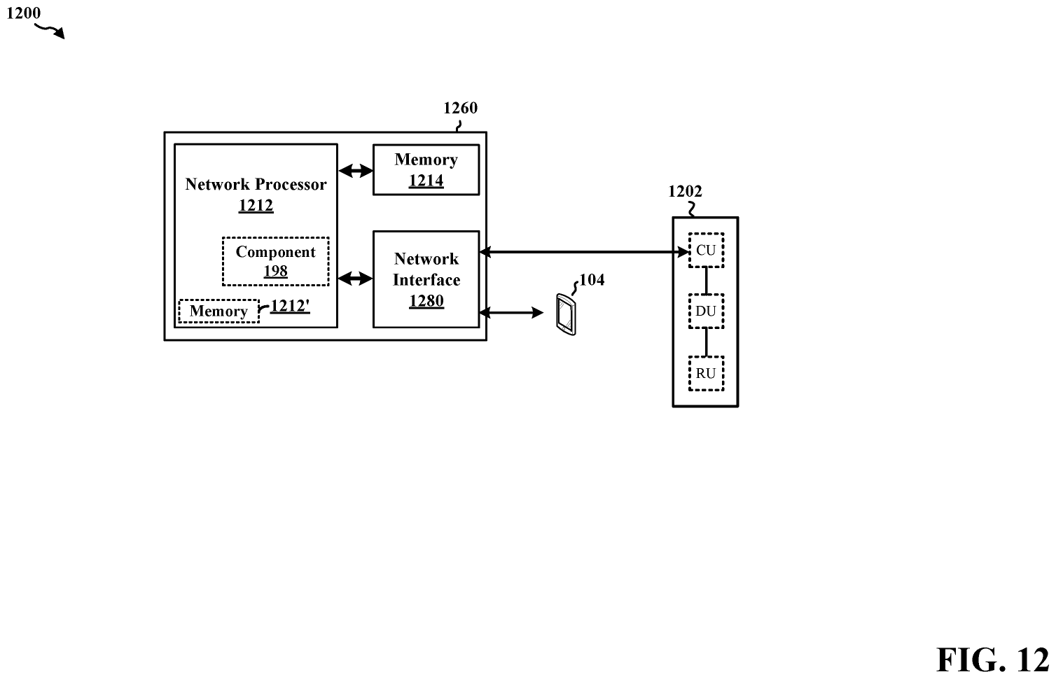

FIG. 8 is a flowchart 800 illustrating methods of wireless communication at a network entity in accordance with various aspects of the present disclosure. In some aspects, the network entity may be the LMF 166, the LMF 604, or the LMF 704, or the network entity 1260 in the hardware implementation of FIG. 12.

At 802, the network entity may receive at least one of spatial direction information associated with a repeater or beam antenna information associated with the repeater. For example, referring to FIG. 7, the LMF 704, at 712, may receive at least one of spatial direction information associated with the repeater 710 or beam antenna information associated with the repeater 710. In an aspect, 802 may be performed by the angle-based positioning component 198.

The spatial direction information may indicate angular directions associated with each reference signal (e.g., DL-PRSs) transmitted (or to be transmitted) from the repeater 710 (e.g., the angle at which the reference signals are transmitted (or are to be transmitted) from the repeater 710). The beam antenna information may indicate the shape of the beam utilized by repeater 710 for transmission of the reference signals. The shape of the beam may be described in terms of the power of the beam in different directions (e.g., the azimuth, the elevation, etc.).

At 804, the network entity may obtain an indication of a set of beam indexes corresponding to a set of beams associated with the repeater. For example, referring to FIG. 7, the LMF 704, at 714, may obtain an indication of a set of beam indexes corresponding to a set of beams associated with the repeater. In an aspect, 804 may be performed by the angle-based positioning component 198.

In some aspects, the network entity may obtain the indication of the set of beam indexes by receiving, from a network node, the indication of the set of beam indexes. For example, referring to FIG. 7, the LMF 704, at 714, may obtain the indication of the set of beam indexes from the network node 702.

In some aspects, the network entity may obtain the indication of the set of beam indexes by receiving, from an OAM node, the indication of the set of beam indexes. For example, referring to FIG. 7, the LMF 704 may obtain the indication of the set of beam indexes from the OAM node 706, for example, at 712.

In some aspects, the network entity may provide, to a UE, the set of beam indexes based on the indication of the set of beam indexes. For example, referring to FIG. 7, the LMF 704, at 716, may provide, to the UE 708, the set of beam indexes based on the indication of the set of beam indexes.

In some aspects, the network entity may receive an ID that identifies a codebook associated with each of the set of beams corresponding to the set of beam indexes. For example, referring to FIG. 7, the LMF 704, at 714, may receive an ID that identifies a codebook associated with each of the set of beams corresponding to the set of beam indexes.

In some aspects, the network entity may receive an ID that identifies whether the set of beams corresponding to the set of beam indexes includes a downlink beam or an uplink beam. For example, referring to FIG. 7, the LMF 704, at 714 may receive an ID that identifies whether the set of beams corresponding to the set of beam indexes includes a downlink beam or an uplink beam.

At 806, the network entity may provide, for a network node, a request to transmit a set of reference signals or to perform a set of measurements for a positioning session based on the set of beam indexes and at least one of the spatial direction information or the beam antenna information. For example, referring to FIG. 7, in an aspect in which the network node is the network node 702, the LMF 704, at 726, may provide a request to the network node 702 to transmit a set of reference signals for a positioning session based on the set of beam indexes and at least one of the spatial direction information or the beam antenna information. In another example, referring to FIG. 7, in an aspect in which the network node is one of a UE (e.g., the UE 708) or a base station (e.g., the network node 702), the LMF 704, at 728, may provide a request to the UE 708 and/or the network node 702 to perform a set of measurements for a positioning session based on the set of beam indexes and at least one of the spatial direction information or the beam antenna information. In an aspect, 806 may be performed by the angle-based positioning component 198.

In some aspects, the network entity may provide, for the network node, QCL information for at least one PRS associated with the repeater based on at least one beam index of the set of beam indexes. For example, referring to FIG. 7, the LMF 704, at 718, may provide, for the network node 702, QCL information for at least one PRS associated with the repeater 710 based on at least one beam index of the set of beam indexes.

In some aspects, the network entity may provide, for the repeater, a request to utilize at least one of a particular spatial direction or a particular beam shape for at least one transmit or receive beam of the repeater. For example, referring to FIG. 7, the LMF 704, at 720 may provide, for the repeater 710, a request to utilize at least one of a particular spatial direction or a particular beam shape for at least one transmit or receive beam of the repeater 710.

In some aspects, the network entity may provide, for the network node, assistance information that indicates one or more beam indexes from the set of beam indexes for the set of measurements. For example, referring to FIG. 7, the LMF 704, at 724, may provide, for the network node 702, assistance information that indicates one or more beam indexes from the set of beam indexes for the set of measurements.

In some aspects, the network entity may provide, for the network node, at least one of the spatial direction information or the beam antenna information based on the reception of at least one of the spatial direction information or the beam antenna information. For example, referring to FIG. 7, the LMF 704, at 715, may provide, for the network node 702, at least one of the spatial direction information or the beam antenna information based on the reception, at 712, of at least one of the spatial direction information or the beam antenna information.

In some aspects, the network entity may receive, from the network node, a measurement report that may be based on the set of measurements, where the measurement report includes an ID of a receive beam associated with the repeater utilized for the set of measurements. For example, referring to FIG. 7, in an aspect in which the network node is the UE 708, the LMF 704, at 736, may receive, from the UE 708, a measurement report that may be based on the set of measurements, where the measurement report includes an ID of a receive beam associated with the repeater 710 utilized for the set of measurements.

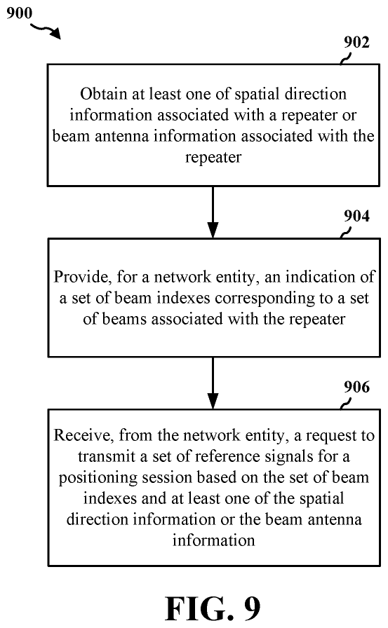

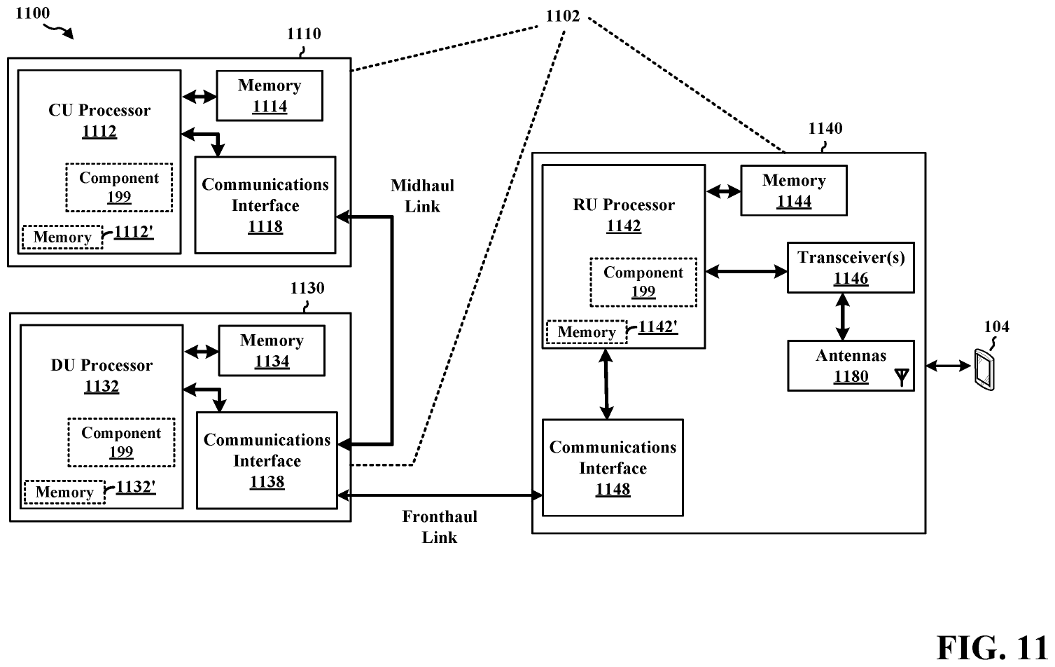

FIG. 9 is a flowchart 900 illustrating methods of wireless communication at a network node in accordance with various aspects of the present disclosure. In some aspects, the network node may be the base station 102, the base station 310, the TRP 402, the TRP 406, the network node 502, the network node 602, or the network node 702 or the network entity 1102 in the hardware implementation of FIG. 11.

At 902, the network node may obtain at least one of spatial direction information associated with a repeater or beam antenna information associated with the repeater. For example, referring to FIG. 7, in some aspects, the network node 702, at 715, may obtain at least one of spatial direction information associated with the repeater 710 or beam antenna information associated with the repeater 710. In other aspects, the network node 702 may obtain at least one of the spatial direction information associated with the repeater 710 or the beam antenna information associated with the repeater 710 from the OAM node 706. In an aspect, 902 may be performed by the angle-based positioning component 199.

The spatial direction information may indicate angular directions associated with each reference signal (e.g., DL-PRSs) transmitted (or to be transmitted) from the repeater 710 (e.g., the angle at which the reference signals are transmitted (or are to be transmitted) from the repeater 710). The beam antenna information may indicate the shape of the beam utilized by repeater 710 for transmission of the reference signals. The shape of the beam may be described in terms of the power of the beam in different directions (e.g., the azimuth, the elevation, etc.).

In an aspect, the network node may obtain at least one of the spatial direction information associated with the repeater or the beam antenna information associated with the repeater by receiving, from a network entity, at least one of the spatial direction information or the beam antenna information. For example, referring to FIG. 7, the network node 702, at 715, may receive, from the LMF 704, at least one of the spatial direction information associated with repeater 710 or the beam antenna information associated with the repeater 710.

At 904, the network node may provide, for a network entity, an indication of a set of beam indexes corresponding to a set of beams associated with the repeater. For example, referring to FIG. 7, the network node 702, at 714, may provide, to the LMF 704, an indication of a set of beam indexes corresponding to a set of beams associated with the repeater. In an aspect, 904 may be performed by the angle-based positioning component 199.

In some aspects, the network node may provide, for the network entity, an ID that identifies a codebook associated with each of the set of beams corresponding to the set of beam indexes. For example, referring to FIG. 7, the network node 702, at 714, may provide, for the LMF 704, an ID that identifies a codebook associated with each of the set of beams corresponding to the set of beam indexes.

In some aspects, the network node may provide, for the network entity, an ID that identifies whether the set of beams corresponding to the set of beam indexes includes a downlink beam or an uplink beam. For example, referring to FIG. 7, the network node 702, at 714, may provide, for the LMF 704, an ID that identifies whether the set of beams corresponding to the set of beam indexes includes a downlink beam or an uplink beam.

At 906, the network node may receive, from the network entity, a request to transmit a set of reference signals or perform a set of measurements for a positioning session based on the set of beam indexes and at least one of the spatial direction information or the beam antenna information. For example, referring to FIG. 7, the network node 702, at 726, may receive, from the LMF 704, a request to transmit a set of reference signals or, at 728, may receive, from the LMF 704 a request to perform a set of measurements for a positioning session based on the set of beam indexes and at least one of the spatial direction information or the beam antenna information. In an aspect, 906 may be performed by the angle-based positioning component 199.

In some aspects, the network node may receive, from the network entity, QCL information for at least one PRS associated with the repeater based on at least one beam index of the set of beam indexes. The network node may provide, for the repeater, a second request to forward the set of reference signals based on the QCL information. For example, referring to FIG. 7, the network node 702, at 718, may receive, from the LMF 704, QCL information for at least one PRS associated with the repeater 710 based on at least one beam index of the set of beam indexes. The network node 702 may provide, for the repeater 710, a second request, at 719, to forward the set of reference signals (e.g., at 730) based on the QCL information.

In some aspects, the network node may receive, from the network entity, assistance information that indicates one or more beam indexes from the set of beam indexes, and may perform a set of uplink measurements for the positioning session based on the assistance information. For example, referring to FIG. 8, the network node 702, at 724, may receive, from the LMF 704, assistance information that indicates one or more beam indexes from the set of beam indexes. At 735, the network node 702 may perform a set of uplink measurements for the positioning session based on the assistance information received at 724.

In some aspects, the set of uplink measurements includes a set of uplink AOA measurements. For example, referring to FIG. 7, the set of uplink measurements performed at 735 may include a set of uplink AoA measurements.

In some aspects, the network node may provide, for the network entity, a measurement report that may be based on the set of uplink AoA measurements. For example, referring to FIG. 7, the network node 702, at 738, may provide, for the LMF 704, a measurement report that may be based on the set of uplink AoA measurements.

In some aspects, the measurement report includes an ID of a receive beam associated with the repeater utilized for the set of uplink AoA measurements. For example, referring to FIG. 7, the measurement report provided by the network node 702 at 738 may include an ID of a receive beam associated with the repeater 710 utilized for the set of uplink AoA measurements (e.g., the receive beam via which the set of uplink reference signals are provided by the repeater 710).

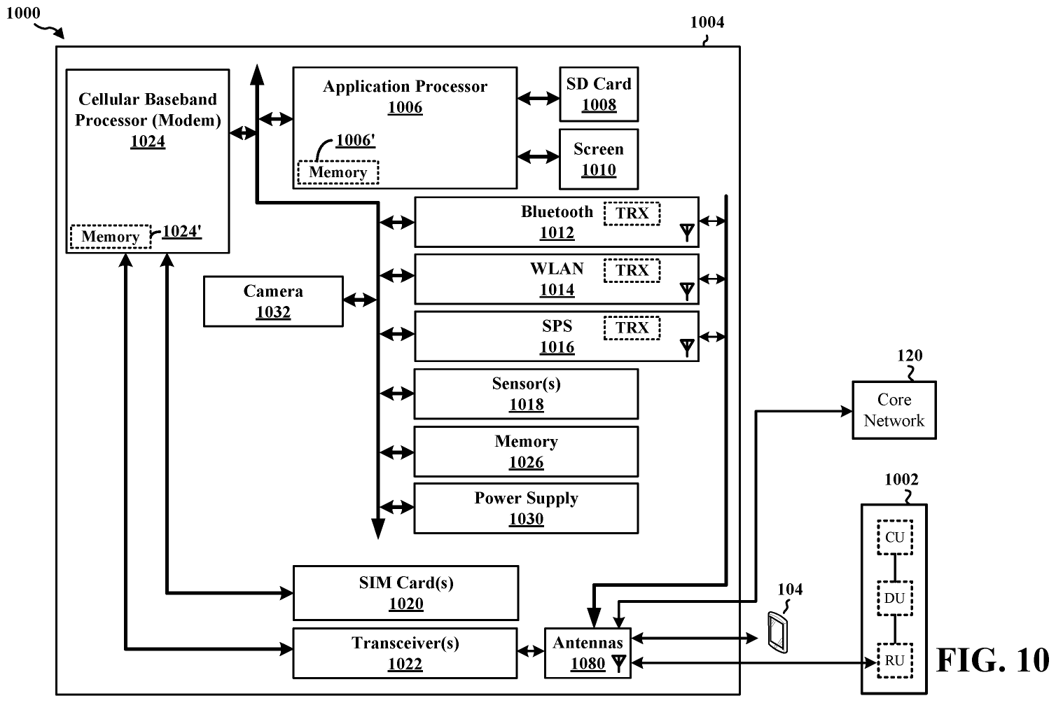

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104, the core network 120 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see UE 350 of FIG. 3) and include the additional modules of the apparatus 1004.

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′. 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to obtain at least one of spatial direction information associated with a repeater or beam antenna information associated with the repeater, provide, for a network entity, an indication of a set of beam indexes corresponding to a set of beams associated with the repeater, and receive, from the network entity, a request to transmit a set of reference signals for a positioning session based on the set of beam indexes and at least one of the spatial direction information or the beam antenna information. The component 199 may be configured to perform any of the aspects described in connection with the flowchart in FIG. 9 and/or the aspects performed by the network node 702 in the communication flow in FIG. 7. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 may include means for obtaining at least one of spatial direction information associated with a repeater or beam antenna information associated with the repeater, means for providing, for a network entity, an indication of a set of beam indexes corresponding to a set of beams associated with the repeater, and means for receiving, from the network entity, a request to transmit a set of reference signals for a positioning session based on the set of beam indexes and at least one of the spatial direction information or the beam antenna information. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 12 is a diagram 1200 illustrating an example of a hardware implementation for a network entity 1260. In one example, the network entity 1260 may be within the core network 120. The network entity 1260 may include a network processor 1212. The network processor 1212 may include on-chip memory 1212′. In some aspects, the network entity 1260 may further include additional memory modules 1214. The network entity 1260 communicates via the network interface 1280 directly (e.g., backhaul link) or indirectly (e.g., through a RIC) with the CU 1202 and the UE 104. The on-chip memory 1212′ and the additional memory modules 1214 may each be considered a computer-readable medium/memory. Each computer-readable medium/memory may be non-transitory. The processor 1212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive at least one of spatial direction information associated with a repeater or beam antenna information associated with the repeater, obtain an indication of a set of beam indexes corresponding to a set of beams associated with the repeater, and provide, for a network node, a request to transmit a set of reference signals or to perform a set of measurements for a positioning session based on the set of beam indexes and at least one of the spatial direction information or the beam antenna information. The component 199 may be configured to perform any of the aspects described in connection with the flowchart in FIG. 8 and/or the aspects performed by the LMF 704 in the communication flow in FIG. 7. The component 198 may be within the processor 1212. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1260 may include a variety of components configured for various functions. In one configuration, the network entity 1260 may include means for receiving at least one of spatial direction information associated with a repeater or beam antenna information associated with the repeater, means for obtaining an indication of a set of beam indexes corresponding to a set of beams associated with the repeater, and means for providing, for a network node, a request to transmit a set of reference signals or to perform a set of measurements for a positioning session based on the set of beam indexes and at least one of the spatial direction information or the beam antenna information. The means may be the component 198 of the network entity 1260 configured to perform the functions recited by the means.

Various aspects relate generally to positioning systems. Some aspects more specifically relate to angle-based positioning based on reference signals transmitted by a repeater. In some examples, a network entity (e.g., a location management function (LMF)) may obtain spatial direction information associated with a repeater (e.g., the angle at which each reference signal transmitted by the repeater is transmitted) and/or beam antenna information associated with the repeater (e.g., the shape of the beam utilized by the repeater for transmission of the reference signals). The network entity may also obtain (e.g., from a network node) an indication of a set of beam indexes corresponding to a set of beams associated with the repeater. The network entity may, based on the set of beam indexes and the spatial direction information and/or the beam antenna information, provide a request (e.g., to the network node) to transmit a set of reference signals or a request (e.g., to a UE) to perform a set of measurements for a positioning session.

Particular aspects of the subject matter described in this disclosure can be implemented to realize one or more of the following potential advantages. In some examples, by considering the spatial information and/or beam antenna information of a repeater when performing the positioning session, the angles at which the repeater transmits reference signals and the beam shape of the beam utilized to transmit such reference signals may be determined. Such information may be leveraged to more accurately determine a positioning result or state (e.g., the location, heading, and/or velocity) of a target entity.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a network entity, including receiving at least one of spatial direction information associated with a repeater or beam antenna information associated with the repeater; obtaining an indication of a set of beam indexes corresponding to a set of beams associated with the repeater; and providing, for a network node, a request to transmit a set of reference signals or to perform a set of measurements for a positioning session based on the set of beam indexes and at least one of the spatial direction information or the beam antenna information.
Aspect 2 is the method of aspect 1, where the network node is one of a UE or a base station, and where providing the request includes: providing, for one of the UE or the base station, the request to perform the set of measurements for the positioning session based on the set of beam indexes and at least one of the spatial direction information or the beam antenna information.
Aspect 3 is the method of aspect 1, where the network node is a base station, and where providing the request includes: providing, for the network node, the request to transmit the set of reference signals for the positioning session based on the set of beam indexes and at least one of the spatial direction information or the beam antenna information.
Aspect 4 is the method of any of aspects 1 to 3, where obtaining the indication of the set of beam indexes includes: receiving, from the network node, the indication of the set of beam indexes.
Aspect 5 is the method of any of aspects 1 to 4, further including: providing, to a UE, the set of beam indexes based on the indication of the set of beam indexes.
Aspect 6 is the method of any of aspects 1 to 5, further including: providing, for the network node, QCL information for at least one PRS associated with the repeater based on at least one beam index of the set of beam indexes.
Aspect 7 is the method of any of aspects 1 to 6, further including: providing, for the repeater, a request to utilize at least one of a particular spatial direction or a particular beam shape for at least one transmit or receive beam of the repeater.
Aspect 8 is the method of any of aspects 1 to 3 and 5 to 7, where obtaining the indication of the set of beam indexes includes: receiving, from an operations, administration, and maintenance (OAM), the indication of the set of beam indexes; and providing, for the network node, assistance information that indicates one or more beam indexes from the set of beam indexes for the set of measurements.
Aspect 9 is the method of any of aspects 1 to 8, further including: receiving, from the network node, a measurement report that is based on the set of measurements, where the measurement report includes an ID of a receive beam associated with the repeater utilized for the set of measurements.
Aspect 10 is the method of any of aspects 1 to 9, further including: providing, for the network node, at least one of the spatial direction information or the beam antenna information based on the reception of at least one of the spatial direction information or the beam antenna information.
Aspect 11 is the method of any of aspects 1 to 10, further including: receiving an ID that identifies a codebook associated with each of the set of beams corresponding to the set of beam indexes.
Aspect 12 is the method of any of aspects 1 to 11, further including: receiving an ID that identifies whether the set of beams corresponding to the set of beam indexes includes a downlink beam or an uplink beam.
Aspect 13 is a method of wireless communication at a network node, including: obtaining at least one of spatial direction information associated with a repeater or beam antenna information associated with the repeater; providing, for a network entity, an indication of a set of beam indexes corresponding to a set of beams associated with the repeater; and receiving, from the network entity, a request to transmit a set of reference signals or perform a set of measurements for a positioning session based on the set of beam indexes and at least one of the spatial direction information or the beam antenna information.
Aspect 14 is the method of aspect 13, further including: receiving, from the network entity, QCL information for at least one PRS associated with the repeater based on at least one beam index of the set of beam indexes; and providing, for the repeater, a second request to forward the set of reference signals based on the QCL information.
Aspect 15 is the method of any of aspects 13 and 14, further including: receiving, from the network entity, assistance information that indicates one or more beam indexes from the set of beam indexes; and performing a set of uplink measurements for the positioning session based on the assistance information.
Aspect 16 is the method of aspect 15, where the set of uplink measurements includes a set of uplink AoA measurements.
Aspect 17 is the method of any of aspects 13 to 16, further including: providing, for the network entity, a measurement report that is based on the set of uplink AoA measurements.
Aspect 18 is the method of aspect 17, where the measurement report includes an ID of a receive beam associated with the repeater utilized for the set of uplink AoA measurements.
Aspect 19 is the method of any of aspects 13 to 18, where obtaining at least one of the spatial direction information or the beam antenna information includes: receiving, from the network entity, at least one of the spatial direction information or the beam antenna information.
Aspect 20 is the method of any of aspects 13 to 19, further including: providing, for the network entity, an ID that identifies a codebook associated with each of the set of beams corresponding to the set of beam indexes.
Aspect 21 is the method of any of aspects 13 to 20, further including: providing, for the network entity, an ID that identifies whether the set of beams corresponding to the set of beam indexes includes a downlink beam or an uplink beam.
Aspect 22 is an apparatus for wireless communication at a network entity. The apparatus includes memory; and at least one processor coupled to the memory and, based at least in part on information stored in the memory, the at least one processor is configured to implement any of aspects 1 to 12.
Aspect 23 is the apparatus of aspect 22, further including at least one of a transceiver or an antenna coupled to the at least one processor.
Aspect 24 is an apparatus for wireless communication at a network node. The apparatus includes memory; and at least one processor coupled to the memory and, based at least in part on information stored in the memory, the at least one processor is configured to implement any of aspects 13 to 21.
Aspect 25 is the apparatus of aspect 24, further including at least one of a transceiver or an antenna coupled to the at least one processor.
Aspect 26 is an apparatus for wireless communication including means for implementing any of aspects 1 to 12.
Aspect 27 is an apparatus for wireless communication including means for implementing any of aspects 13 to 21.
Aspect 28 is a computer-readable medium (e.g., a non-transitory computer-readable medium) storing computer executable code, where the code when executed by a processor causes the processor to implement any of aspects 1 to 12.
Aspect 29 is a computer-readable medium (e.g., a non-transitory computer-readable medium) storing computer executable code, where the code when executed by a processor causes the processor to implement any of aspects 13 to 21.

What is claimed is:

1. An apparatus for wireless communication at a network entity, comprising:
a memory; and
at least one processor coupled to the memory and, based at least in part on information stored in the memory, the at least one processor is configured to:
receive at least one of spatial direction information associated with a repeater or beam antenna information associated with the repeater;
obtain an indication of a set of beam indexes corresponding to a set of beams associated with the repeater; and
provide, for a network node, a request to transmit a set of reference signals or to perform a set of measurements for a positioning session based on the set of beam indexes and at least one of the spatial direction information or the beam antenna information.

2. The apparatus of claim 1, wherein the network node is one of a user equipment (UE) or a base station, and wherein, to provide the request, the at least one processor is configured to:
provide, for one of the UE or the base station, the request to perform the set of measurements for the positioning session based on the set of beam indexes and at least one of the spatial direction information or the beam antenna information.

3. The apparatus of claim 1, wherein the network node is a base station, and wherein, to provide the request, the at least one processor is configured to:
provide, for the network node, the request to transmit the set of reference signals for the positioning session based on the set of beam indexes and at least one of the spatial direction information or the beam antenna information.

4. The apparatus of claim 1, wherein, to obtain the indication of the set of beam indexes, the at least one processor is configured to:
receive, from the network node, the indication of the set of beam indexes.

5. The apparatus of claim 1, wherein the at least one processor is further configured to:
provide, to a user equipment (UE), the set of beam indexes based on the indication of the set of beam indexes.

6. The apparatus of claim 1, wherein the at least one processor is further configured to:
provide, for the network node, quasi-co-location (QCL) information for at least one positioning reference signal (PRS) associated with the repeater based on at least one beam index of the set of beam indexes.

7. The apparatus of claim 1, wherein the at least one processor is further configured to:
provide, for the repeater, a request to utilize at least one of a particular spatial direction or a particular beam shape for at least one transmit or receive beam of the repeater.

8. The apparatus of claim 1, wherein, to obtain the indication of the set of beam indexes, the at least one processor is configured to:
receive, from an operations, administration, and maintenance (OAM), the indication of the set of beam indexes; and
provide, for the network node, assistance information that indicates one or more beam indexes from the set of beam indexes for the set of measurements.

9. The apparatus of claim 1, wherein the at least one processor is further configured to:
receive, from the network node, a measurement report that is based on the set of measurements, wherein the measurement report comprises an identifier (ID) of a receive beam associated with the repeater utilized for the set of measurements.

10. The apparatus of claim 1, wherein the at least one processor is further configured to:
provide, for the network node, at least one of the spatial direction information or the beam antenna information based on the reception of at least one of the spatial direction information or the beam antenna information.

11. The apparatus of claim 1, wherein the at least one processor is further configured to:
receive an identifier (ID) that identifies a codebook associated with each of the set of beams corresponding to the set of beam indexes.

12. The apparatus of claim 1, wherein the at least one processor is further configured to:
receive an identifier (ID) that identifies whether the set of beams corresponding to the set of beam indexes includes a downlink beam or an uplink beam.

13. The apparatus of claim 1, further comprising at least one of a transceiver or an antenna coupled to the at least one processor, wherein to receive at least one of the spatial direction information or the beam antenna information, the at least one processor is configured to receive, via at least one of the transceiver or the antenna, at least one of the spatial direction information or the beam antenna information.

14. An apparatus for wireless communication at a network node, comprising:
a memory; and
at least one processor coupled to the memory and, based at least in part on information stored in the memory, the at least one processor is configured to:
obtain at least one of spatial direction information associated with a repeater or beam antenna information associated with the repeater;
provide, for a network entity, an indication of a set of beam indexes corresponding to a set of beams associated with the repeater; and
receive, from the network entity, a request to transmit a set of reference signals or perform a set of measurements for a positioning session based on the set of beam indexes and at least one of the spatial direction information or the beam antenna information.

15. The apparatus of claim 14, wherein the at least one processor is further configured to:
receive, from the network entity, quasi-co-location (QCL) information for at least one positioning reference signal (PRS) associated with the repeater based on at least one beam index of the set of beam indexes; and
provide, for the repeater, a second request to forward the set of reference signals based on the QCL information.

16. The apparatus of claim 14, wherein the at least one processor is further configured to:
receive, from the network entity, assistance information that indicates one or more beam indexes from the set of beam indexes; and
perform a set of uplink measurements for the positioning session based on the assistance information.

17. The apparatus of claim 16, wherein the set of uplink measurements comprises a set of uplink angle-of-arrival (AoA) measurements.

18. The apparatus of claim 17, wherein the at least one processor is further configured to:
provide, for the network entity, a measurement report that is based on the set of uplink AoA measurements.

19. The apparatus of claim 18, wherein the measurement report comprises an identifier (ID) of a receive beam associated with the repeater utilized for the set of uplink AoA measurements.

20. The apparatus of claim 14, wherein, to obtain at least one of the spatial direction information or the beam antenna information, the at least one processor is configured to:
receive, from the network entity, at least one of the spatial direction information or the beam antenna information.

21. The apparatus of claim 14, wherein the at least one processor is further configured to:
provide, for the network entity, an identifier (ID) that identifies a codebook associated with each of the set of beams corresponding to the set of beam indexes.

22. The apparatus of claim 14, wherein the at least one processor is further configured to:
provide, for the network entity, an identifier (ID) that identifies whether the set of beams corresponding to the set of beam indexes includes a downlink beam or an uplink beam.

23. The apparatus of claim 14, further comprising at least one of a transceiver or an antenna coupled to the at least one processor, wherein to receive the request, the at least one processor is configured to receive, via at least one of the transceiver or the antenna, the request.

24. A method for wireless communication at a network entity, comprising:
receiving at least one of spatial direction information associated with a repeater or beam antenna information associated with the repeater;
obtaining an indication of a set of beam indexes corresponding to a set of beams associated with the repeater; and
providing, for a network node, a request to transmit a set of reference signals or to perform a set of measurements for a positioning session based on the set of beam indexes and at least one of the spatial direction information or the beam antenna information.

25. The method of claim 24, wherein the network node is a user equipment (UE), and wherein providing the request comprises:
providing, for the UE, the request to perform the set of measurements for the positioning session based on the set of beam indexes and at least one of the spatial direction information or the beam antenna information.

26. The method of claim 24, wherein the network node is a base station, and wherein providing the request comprises:
providing, for the network node, the request to transmit the set of reference signals for the positioning session based on the set of beam indexes and at least one of the spatial direction information or the beam antenna information.

27. The method of claim 24, wherein obtaining the indication of the set of beam indexes comprises:
receiving, from the network node, the indication of the set of beam indexes.

28. The method of claim 24, further comprising:
providing, to a user equipment (UE), the set of beam indexes based on the indication of the set of beam indexes.

29. A method for wireless communication at a network node, comprising:
obtaining at least one of spatial direction information associated with a repeater or beam antenna information associated with the repeater;
providing, for a network entity, an indication of a set of beam indexes corresponding to a set of beams associated with the repeater; and
receiving, from the network entity, a request to transmit a set of reference signals or perform a set of measurements for a positioning session based on the set of beam indexes and at least one of the spatial direction information or the beam antenna information.

30. The method of claim 29, further comprising:
receiving, from the network entity, quasi-co-location (QCL) information for at least one positioning reference signal (PRS) associated with the repeater based on at least one beam index of the set of beam indexes; and
providing, for the repeater, a second request to forward the set of reference signals based on the QCL information.
